(19) United States
(12) Patent Application Publication
(10) Pub. No.: US 2004/0059780 A1
(43) Pub. Date: Mar. 25, 2004

(54) Data transmission

(75) Inventor: Fabio Giannetti, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/669,056

(22) Filed: Sep. 24, 2003

(30) Foreign Application Priority Data
Sep. 24, 2002 (GB) 0222232.1

(51) Int. Cl. G06F 15/16

(52) U.S. Cl. 709/203; 715/513; 709/246

(57) ABSTRACT

A method of generating data suitable for transmission to at least one of a predetermined combination of at least a first and a second data-receiving device, said method comprising providing identifiers associated with portions of said data, and arranged to identity that portion of the data, and selecting portions of the data for transmission to at least one of said data-receiving devices depending upon rules for the predetermined combination of first and second data-receiving devices that specify to which device a portion of the data having a predetermined identifier should be sent. Such a method may allow a pair of data receiving devices to be used as a pair of devices rather than as two separate data-receiving devices.

### FIELD OF THE INVENTION

This invention relates to a method and apparatus for generating data suitable for transmission, especially, but not exclusively, to devices remote from a processing apparatus, such as a computer.

### BACKGROUND OF THE INVENTION

Data delivery to computing devices remote from a server is well known and commonly used across the Internet and the World Wide Web. Presently, there is a growing trend to access data from a variety of devices. For example WAP enabled telephones, web enabled television sets, computers such as PC's, Apple iMacs, etc., PDA's and the like are all becoming used for the access of data across networks such as the Internet. It will be appreciated that such a diverse range of computing devices has different capabilities for handling and displaying data. Therefore, it is generally desirable to tailor the data according to the device to which it is being delivered.

It is known to provide style sheets and the like to adapt data so that it is suitable for a particular class, or a specific model, of computing device. An example of this is described in WO 01/63481, in the name of Sun Microsystems, Inc. However, such an arrangement can lead to there being a requirement for a large number of style sheets in certain situations, perhaps leading excessive amounts of data and a burden to ensure that all of the style sheets were functioning correctly, etc.

### SUMMARY OF THE INVENTION

According to a first aspect of the invention there is provided a method of generating data suitable for transmission to at least one of a predetermined combination of at least a first and a second data-receiving device, said method comprising providing identifiers associated with portions of said data, and arranged to identity that portion of the data, and selecting portions of the data for transmission to at least one of said data-receiving devices depending upon rules for the predetermined combination of first and second data-receiving devices that specify to which device a portion of the data having a predetermined identifier should be sent.

An advantage of such a method is that allows the two data-receiving devices to be used in conjunction with one another with the data being shared between the two devices as deemed appropriate and as specified within the rules. Further, the method can allow a reduction in the number of style sheets that would be required by the prior art. Prior art techniques would require a separate style sheet for each combination of devices that were envisaged. In order to achieve the result required under the prior art system, an author would have to produce a style sheet for each page to be produced from the data as it should be displayed on each data-receiving device when that data-receiving device was part of a specific combination. The number of style sheets required would then be N×M×D, where N is the number of pages, M the number of different data-receiving devices and D the number of device data-receiving combinations. The present method may reduce this. Clearly, the reduction of style sheets in this manner provides a number of technical advantages, which include at least the following: reduction in the storage space required; the speed at which the data can be generated prior to delivery will increased (processing fewer style sheets will take less time); there are likely to be less mistakes in generating the rules when compared to writing a plurality of style sheets

The identifiers are preferably placed within the data prior to generation of the data suitable for transmission. Generally this will be at the time the data is created. For example if the data were to create a page for a web site then the identifiers may included at the time the author wrote the page.

Preferably, the identifiers provide an indication as to the intended function of the portion of the data with which they are associated. The rules may specify to which device a portion of data should be sent according to that portions intended function. Examples of intended functions include: navigation, headings, content, pictures, sounds, executable code, video footage, data entry forms, and the like.

The identifiers may also provide an indication of the importance of a portion of data relative to other portions of the same data. In one embodiment the identifiers provide an indication as to whether that portion of the data is of high, medium or low importance. In other embodiments the identifiers may provide a ranking on a numerical scale, or on an alphanumeric scale. Indeed, any method of indicating relative importance between portions of the data may be used.

The method may comprise generating a set of rules which are used as a default in order to determine to which data-receiving device the data should be sent. Such an arrangement is advantageous because it may allow data to be sent to the at least one data-receiving device with less user input than if it were required to set up a rule before data transmission may occur.

Further, the method may allow a user to alter the rules. Such a method is believed to be advantageous because it may allow him/her to tailor how data is sent to the data-receiving devices that they are using according to his/her wishes.

The method may comprise writing the data in a data-receiving device independent language, which in the preferred embodiment is XML. Such a method is advantageous because it allows a single version, containing the identifiers, to be stored and then adapted into a device specific language before transmission to a predetermined data-receiving device.

The method may be arranged to send portions of the data to the data-receiving device that has the more appropriate handling capabilities for that portion of the data.

Conveniently, the method may be used to generate data for any number of data-receiving devices, generally different from one another. For example the method may be used to generate data for 3,4,5,6,7,8,9,10 or more devices.

According to a second aspect of the invention there is provided a computing device arranged to hold data intended for transmission to at least one of a predetermined combination of at least a first and a second data-receiving devices, said computing device comprising a transmitting means for transmitting data from the device, a receiving means for receiving data to the device, storage means for storing data together with a set of rules determining how data should be processed and a processing unit for processing data wherein the receiving means is arranged to receive a request for data and pass said request to said processing unit, said processing unit being arranged to access data stored in said storage means, determine to which of the at least two data-receiving devices at least a portion of the data should be sent according to the rules held on the storage means together with identifiers held within said data and further arranged to pass said data, that said processing unit determines should be transmitted, to said transmitting means wherein said transmitting means is arranged to transmit said data it has been passed to at least one of said data-receiving devices.

The computing device may comprise a server for a network, a router, or the like.

The transmitting means and receiving means may be arranged to provide access to a network. The network may be Local Area Network (LAN), a Wide Area Network (WAN), the Internet, or indeed any form of network whether wired, or wireless.

According to a third aspect of the invention there is provided a device that is arranged to establish a data connection between a computing device and at least a first and a second data receiving device wherein said first and said second data receiving devices are intended to be used in conjunction, said device comprising a receiving means for receiving data from said data connection, a transmitting means arranged to send data over said data connection and a processing unit arranged to process data, said device being arranged such that when it establishes said data connection, said processing unit is arranged to cause said transmitting means to transmit the identity of said first and said second data-receiving device.

Preferably said device is one of the first and second data-receiving devices.

Such a device is advantageous because it may be used in conjunction with the second data receiving device, therefore, providing a pair of data-receiving devices, possibly with a joint functionality, rather than two separate data receiving devices. For example the first data receiving device may be arranged such that it can receive and transmit data such that it can control the data that is sent to the second data receiving device.

Alternatively, said device is distinct from said first and said second data receiving devices, e.g. servelet.

For example, in one embodiment, the identity may comprise in part a session ID, said first and said second data receiving devices having a common session ID.

According to a fourth aspect of the invention there is provided a network comprising at least one computing device and at least two data receiving device, the computing device being arranged to make data connections to said two or more data-receiving devices said computing device comprising a transmitting means for transmitting data from the device, a receiving means for receiving data to the device, storage means for storing data together with a set of rules determining how data should be processed and a processing unit for processing data wherein the receiving means is arranged to receive a request for data and pass said request to said processing unit, said processing unit being arranged to access data stored in said storage means, determine to which of the at least two data-receiving devices at least a portion of the data should be sent according to the rules held on the storage means together with identifiers held within said data and further arranged to pass said data, that said processing unit determines should be transmitted, to said transmitting means wherein said transmitting means is arranged to transmit said data it has been passed to at least one of said data-receiving devices and said at least two data-receiving devices being arranged to receive data from the computing device.

According to a fifth aspect of the invention there is provided a computer readable medium containing instructions which when read onto a processing unit cause that processing unit to perform the method of the first aspect of the invention.

According to a sixth aspect of the invention there is provided a computer readable medium containing instructions which when read onto a processing unit to function as the processing unit of the second aspect of the invention.

According to a seventh aspect of the invention there is provided a computer readable medium containing instructions which when read onto a data-receiving device cause that data-receiving device to function as the data-receiving device according to the third aspect of the invention.

According to an eighth aspect of the invention there is provided a computer readable medium containing instructions which when read onto a computing device of a network cause that network to function according to the fourth aspect of the invention.

According to a ninth aspect of the invention there is provided a method of generating data suitable for transmission to at least one of a predetermined combination of at least a first and a second data-receiving device, the method comprising providing data, at least one rule and identifiers, wherein the identifiers are associated with portions of the data and are arranged to identify that portion of the data and the at least one rule specifies for the predetermined combination of first and second data-receiving devices to which device a portion of the data having a predetermined identifier should be sent and the method further comprising selecting portions of the data for transmission to at least one of the data-receiving devices depending upon the at least one rule, wherein the identifiers provide an indication as to the intended function of the portion of the data with which they are associated and the rules specify to which of the first and the second devices data should be sent.

According to a tenth aspect of the invention there is provided a method of creating data intended for transmission to at least one of a combination of at least a first and a second data-receiving device, the method comprising providing data, at least one condition and identifiers, wherein an identifier is associated with a portion of the data and is arranged to identify that portion of the data, and the at least one condition specifies for the combination of first and second data-receiving devices to which device a portion of the data having a predetermined identifier should be sent and the method further comprising selecting portions of the data for transmission to at least one of the data-receiving devices depending upon the at least one condition.

According to a eleventh aspect of the invention there is provided a network comprising at least one computing device and at least two data receiving devices, the computing device being arranged to make data connections to the at least two data receiving devices used in conjunction with one another such that predetermined data is handled by one of the data handling devices and other predetermined data is handled by another of the data handling devices, the computing device comprising a processor, a transmitter, a receiver, and a memory arranged to store data including identifiers identifying predetermined data to be sent to one of the data receiving devices together with a set of rules determining how data should be processed, wherein the receiver is arranged to receive a request for data and pass the request to the processor, the processor being arranged to access data stored in the memory, determine to which of the at least two data receiving devices at least a portion of the data should be sent according to the rules held in the memory together with the identifiers held within the data and further arranged to pass the data that the processor determines should be transmitted to the transmitter and wherein the transmitter is arranged to transmit the data it has been passed to at least one of the data receiving devices at any one time and the at least one data-receiving devices being arranged to receive data from the computing device.

According to a twelfth aspect of the invention there is provided a device arranged to concurrently establish a data connection with at least a first and a second data-receiving device such that data is sent to one of the first and the second data receiving devices depending upon an identifier within the data wherein the data-receiving devices are intended to be used in conjunction with one another, the device comprising a receiver arranged to receive data from the data connection, a transmitter arranged to send data over the data connection and a processor arranged to process data and to control the receiver and the transmitter, the device being arranged such that when it establishes the data connection the processor is arranged to receive from the receiver the identity of the first and the second data-receiving devices, the device being further arranged to receive data at least a portion of which is intended for the first data-receiving device and at least a portion of which is intended for the second data-receiving device and the processor being further arranged to control the transmitter to transmit each of the portions of the data to the data-receiving device for which they are intended such that at least some of the data is received by the first data receiving device and at least some of the data is received by the second data receiving device.

According to a thirteenth aspect of the invention there is provided a device arranged to concurrently establish a data connection between a computing device and at least a first and a second data-receiving device such that data is sent to one of the first and the second data receiving devices depending upon an identifier within the data wherein the first and the second data-receiving devices are intended to be used in conjunction, the device comprising a receiver arranged to receive data from the data connection, a transmitter arranged to send data over the data connection and a processor arranged to process data and to control the receiver and the transmitter.

The computer readable medium of any of the above aspects of the invention may be any one or more of the following: a floppy disk; a CDROM/RAM; a DVD ROM/RAM (including +RW, −RW); any form of magneto optical disk; a hard drive; a transmitted signal (including an internet download, file transfer, or the like); a wire; or any other form of medium.

### BRIEF DESCRIPTION OF THE DRAWINGS

There now follows by way of example only a detailed description of the present invention with reference to the accompanying drawings of which:

FIG. 1 schematically shows the architecture of a computer capable of acting as a server for this invention;

FIG. 2 shows schematically shows an arrangement for sending data according to an embodiment of the present invention;

FIG. 3 shows a schematically shows how parts single document can be sent to a plurality of different devices;

FIG. 4 schematically shows a device having a low capability display displaying a document;

FIG. 5 schematically shows a device having a medium capability display displaying a document;

FIG. 6 schematically shows a device having a high capability display displaying a document;

FIG. 7 schematically shows a device having no display capabilities;

FIG. 8 show an example of a web-site as it may be displayed on a screen of a computer;

FIG. 9 shows a prior art arrangement for sending data to a variety of computing devices; and

FIG. 10 shows a flow chart outlining processes running in one embodiment of the present invention.

### DETAILED DESCRIPTION OF THE DRAWINGS

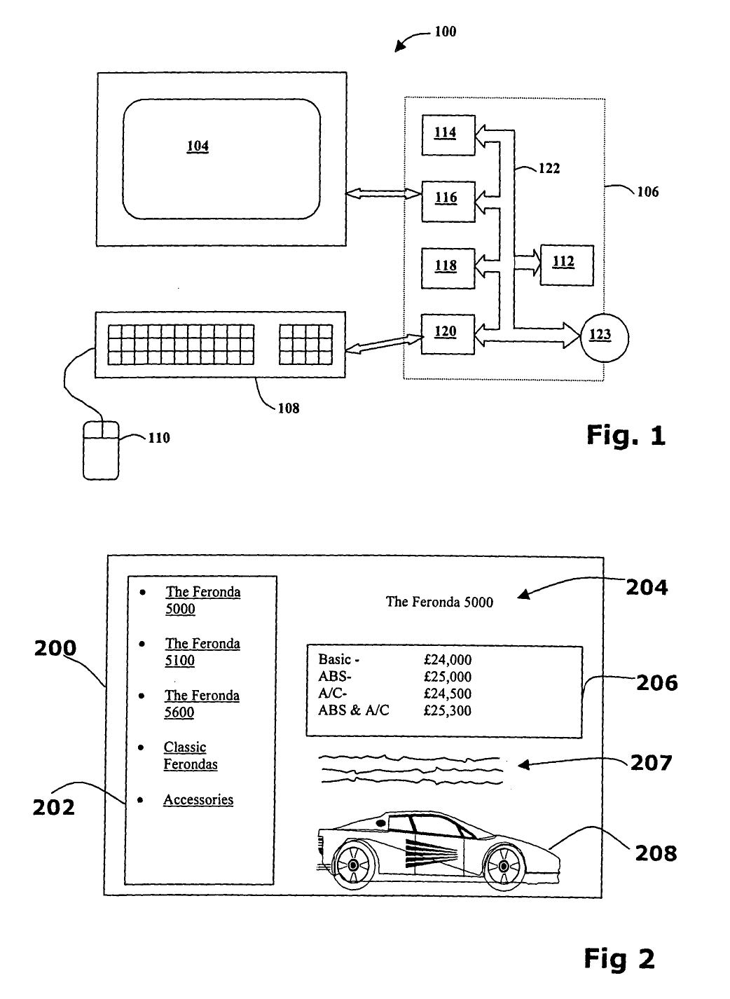

This particular invention is applicable to distribute data electronically, and in particular via the World Wide Web, or in short the web. Such technology is well known. Generally the data to be distributed is held on a processing apparatus, which may also be known as a computing device or server 100, as shown in FIG. 1, and can be requested by any number of devices that are capable of communicating with the server 100. Indeed, a first device can make a request for data to be sent to a second device.

In this embodiment the processing apparatus, or server 100, comprises a display 104, processing circuitry 106, a keyboard 108, and mouse 110. The processing circuitry 106 further comprises a processor in processing unit 112, a hard drive 114, a video driver 116, memory 118 (RAM and ROM) which provides storage an I/O subsystem 120 and an IP Port 123 which all communicate with one another, as is known in the art, via a system bus 122. The processing unit 112 comprises an INTEL™ PENTIUM™ series processor, running at typically between 2 GHz and 2.5 GHz.

As is known in the art the ROM portion of the memory 118 contains the Basic Input Output System (BIOS) that controls basic hardware functionality. The RAM portion of memory 118 is a volatile memory used to hold instructions that are being executed, such as program code, etc. The hard drive 114 provides storage—it is used as mass storage for programs and other data.

The IP port provides a transmitting means and a receiving means (also known as a transmitter and receiver) for the server 100 allowing the server 100 to communicate with other computing devices.

Other devices such as CDROMS, DVD ROMS, network cards, etc. could be coupled to the system bus 122 and allow for storage of data, communication with other computers over a network, etc.

The server 100 could have the architecture known as a PC, originally based on the IBM™ specification, but could equally have other architectures. The server may be an APPLE™, or may be a RISC system, and may run a variety of operating systems (perhaps HP-UX, LINUX, UNIX, MICROSOFT™ NT, AIX™, or the like).

In this embodiment data, in this case a web-site comprising at least two composite parts, described herein as web-site portions, is held on the server 100. FIG. 2 shows an example of a web-site 200 as it may appear on the display 104 of the server 200. The web-site 200 comprises five portions—a menu 202 (which comprise ‘hyperlink’ portions of text which indicate the information available on the web-site 200. A user may navigate between the pages of the web-site 200 by clicking with the button of the mouse 110 when a pointer is positioned on the display 104 over that portion of text), a title 204, some text comprising a price list 206, a portion of descriptive text 207 and a picture 208.

The server 100 stores the web-site 200 and distributes the data contained therein on request to at least a first and a second data-receiving device. The data may have been requested by one of the first and second devices, or by another data-receiving device—that is capable of communicating with the server 100.

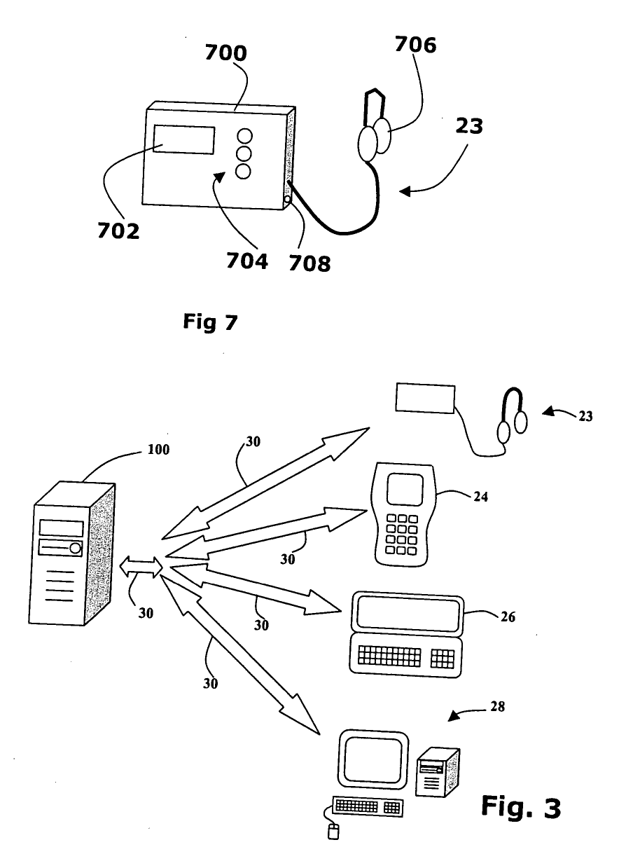

When the server 100 receives a request from a data-receiving device it will forward the requested data to the appropriate data-receiving device, distributing the web-site portions in the manner described below. This is schematically represented in FIG. 3, which shows a headset 23, WAP enabled telephone 24, a landscape oriented PDA 26 and a PC 28 in communication with the server via a network connection 30. This list of devices that can request data from the server 100 as mentioned herein is not exhaustive and provides a first, second, third and fourth data-receiving device.

The WAP enabled telephone 24 comprise an aerial 32 which provides a transmitting and receiving means.

It will be appreciated that each of the data-receiving devices 23,24,26,28 shown in FIG. 3 has a different display capability ranging from not being able to display information at all and providing audio only (the headset 23) to the PC 28 which has the highest display capabilities of the devices listed. Therefore, each of the data receiving devices has a different practical use. Therefore, a web-site portion may advantageously be tailored for each device. This is advantageous for two reasons.

As the first, a document arranged for display on one of the devices will not necessarily be displayed correctly on the other devices. Secondly, it may not be appropriate to display specific data on certain devices. To give an example of this second point, a person giving a lecture may like to control the screen of a PC 28 from a hand-held device such as a PDA 26. In this way, the person would not have to be in close proximity to the PC 28, for example he/she may not need access to a keyboard, thereby potentially removing the possibility of restricting the view of his or her audience.

Alternatively, or additionally, it may be that some data from a web-site may usefully be ‘portable’ for a user—consider for example a sales person, for whom it would be advantageous to carry sales prices, which may be up-dated from time to time. The sales person may not need a picture from the web-site—indeed, most portable devices have restricted memory capabilities, when compared to data-receiving devices such as the PC 28, and it is desirable to carry only the minimum data required on a device such as the PDA 26.

An example of a WAP enabled telephone is the NOKIA™ 7110 that has a black and white display of 96×65 pixels, but only 96×44 pixels are available for body data providing four lines of text at roughly 15 characters per line. The telephone is provided with a keypad 38 through which data can be input thereto. A WAP enabled telephone 34 has restricted capabilities for storing and for processing data.

In this example the PDA 28 is an HP Jornada 690™ that operates using the Microsoft™ PocketPC™ operating system, and runs Microsoft™ Pocket Explorer as its means of communicating with the server 100. The Jornada 690™ has a keyboard, as well as a touch screen input, and can access the web, etc. using modem, or network cards connected through its PC card slot or via its infra-red link. The screen of the Jornada 690™ can display colour and has a resolution of 640×240 pixels (i.e. landscape). (It is also possible for the PDA to have a portrait perspective screen). This PDA has set capabilities for storing and for processing data.

The PC 28 may have an architecture similar to that shown in FIG. 1. Its display is likely to be able to display 24-bit true colour (in excess of 16 million colours) at a resolution of at least 1024×768. Typically, a PC has superior storage and processing capabilities when compared to a PDA.

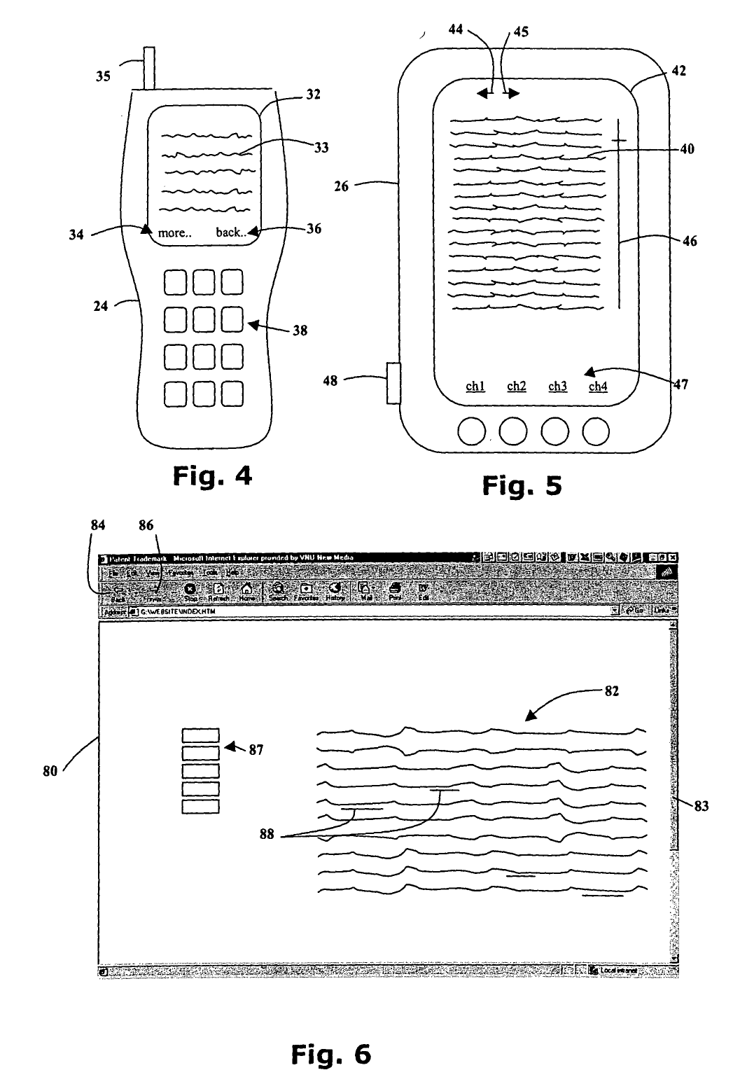

FIG. 4 shows a WAP enabled telephone 24 that has a low capability display 32. When the display is required to display more lines of data, in this example, text 33 than will fit on a screen at any one time, the telephone 24 is arranged to display “more” 34, and “back” 36 indicating to a user that he/she can see earlier and later lines of text. It may be appropriate to display only one of “more”, “back” depending whether there are earlier or later lines of text 33 that can be displayed. To activate the “more”, “later” options a user simply presses designated buttons on the keypad 38 of the telephone 24. The data being displayed by the WAP telephone 24 specifies to where within the data the “more” 34 and “back” 36 options take a user. The WAP telephone 24 further comprises an aerial 35, providing a data transmitting and receiving means.

FIG. 5 shows a portrait oriented PDA 26 with data, in this example, lines of text 40 displayed thereon. Although the display 42 of the PDA 26 is larger than that of the telephone 24 it is smaller than that of the computer 28, and it can therefore, display an intermediate level of data. A user is provided with “forward” 44 and “back” 45 buttons that allows him/her to access the next or previous sections of text that have been visited in his/her recent viewing history. A scroll bar 46 is provided that allows the user to move the text 40 up/down the screen so that text that has run off the bottom/top of the screen 42 can be displayed. Links 47 are shown at a bottom region of the screen 42 that allow a user to access other portions of the document being displayed thereon. It will be appreciated that the functionality of the “forward” button 44, “back” button 45 and the scroll bar 46 are provided by the browser running on the PDA and not by the data being displayed thereon. The PDA 26 further comprises an IP socket 48 through which the PDA 26 can connect to a network and which provides a transmitting and receiving means.

FIG. 6 shows a browser window 80 that is running on a computer 28. The browser window 80 provides a larger area of text 82, than that provided by the WAP enabled telephone 24, or the PDA 26. The browser window 80 provides a “back” button 84, and a “forward” button 86 that can be operated using the Graphical User Interface (GUI) provided by the computer 28 on which the browser window 80 is running. The “forward” and “back” buttons allow a user to move to the next, or previous page that has been visited in his/her viewing session. A scroll bar 83 is provided that allows a user to scroll down the text 82 displayed on the browser window should the text not fit within the display area provided. Buttons 87 and links 88 (usually denoted by the underlining a word) are provided on the screen and allow a user to jump to other data. Again it will be appreciated that the forward button 86, the back button 84, and the scroll bar 83 are provided by the browser running the window, whereas the buttons 87 and the links 88 are provided by the data being displayed by the browser.

The headset 23 shown in FIG. 7 comprises a unit 700 containing a processing circuit arranged to communicate with the server 100 over a communication medium. The unit 700 has a display thereon for displaying information relating to the status of the device 23 to a user thereof. A range or buttons/switches 704 is provided and provide inputs to the processing circuit allowing a user to control the device. The processing circuit is capable of driving a pair of headphones 706 which enables a user to hear data that is received by the headset device 23 which has been received from the server 100. The headset 23 further comprises an IP socket 708 through which the headset 23 can connect to a network. The IP socket 708 therefore provides a transmitting and receiving means.

Thus, as will be appreciated from the foregoing descriptions that, although the data-receiving devices 23,24,26,28 have various mechanisms for conveying data to a user thereof, the amount of data that can be displayed at any one time and therefore how these mechanism are used by the user varies from device to device. Furthermore, it may be appropriate to distribute the data between two or more devices when a single user has the use of more than one data-receiving device 23,24,26,28.

Distributing data between two or more devices takes into account the type of information that it is desirable to display between devices and that in this way the capabilities of the data-receiving devices 23,24,26,28 may be pooled and each used to the best of its capabilities.

It is has previously been a requirement that data be tailored for the device to which it will be transmitted. That is, a separate version of the data would be required for a headset device 23, telephone 24, a PDA 26, a browser on a computer 28. The separate version of the data may be generated using a style sheet to tailor original data for a specific data-receiving device 23,24,26,28 or the original data may be written for a predetermined data-receiving device 23,24,26,28.

Previously tags, or identifiers, have been applied to data items within data specifying whether that data item is appropriate for display on a device having for example, a low, an intermediate, or a high display capability.

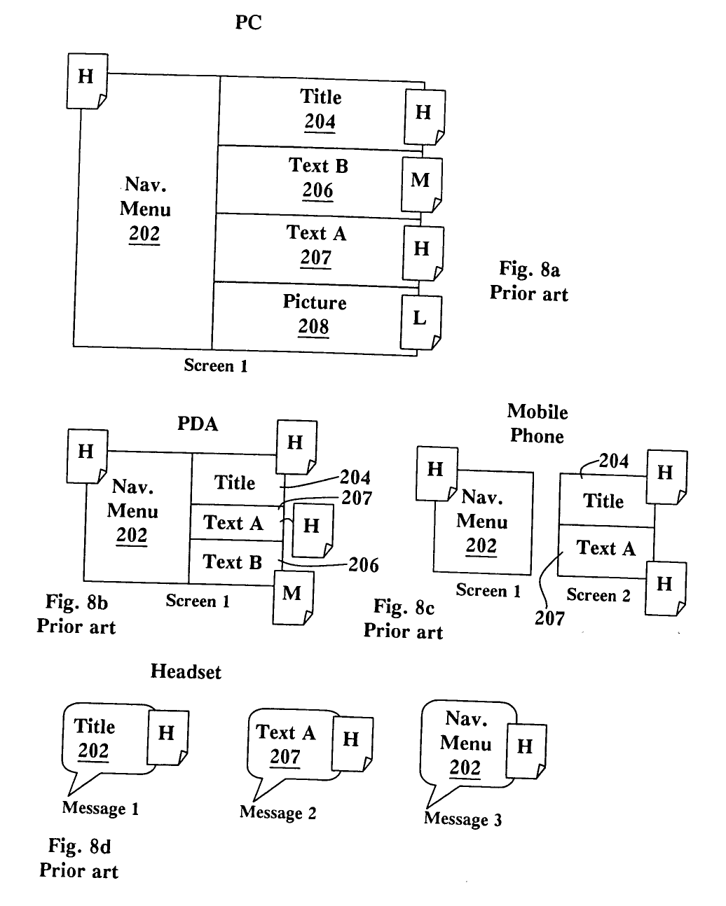

This prior art technique for distributing the content of the web-site 200 between data-receiving devices will now be explained with reference to FIGS. 8a-d. The web site of FIG. 2 can be described as having the structure of FIG. 8a (i.e. the price list forms a body of text B and the portion of descriptive text forms the body of text A). Each of the five portions 202-208 is assigned a priority of one of low, medium, high as indicated by the “H”, “M” or “L”. The web site is provided by a data file containing the relevant code to create each of the five portions and within this code the priority of each portion is specified.

In order to send the web site to each of the data receiving devices the data file is processed by a style sheet which sends only portions of the data file of the correct importance for that device. For example the style sheet for the PC 28 sends all of the high, medium and low priority portions to the PC 28 (FIG. 8a). However, in view of the lower capabilities of the PDA 26 the style sheet adapts the data file so that only the high and medium priority portions are transmitted (FIG. 8b). As can be seen from FIG. 8c the style sheet for a WAP enabled telephone adapts the data file so that only medium and high priority portions are transmitted, but further adapts the data file so that the transmitted data is split across a number of screens. The style sheet for the headset again adapts the data file so that only high and medium priority portions are transmitted, but each portion is transmitted as a separate message (FIG. 8d)

The code shown in the appendices is written in XML (eXtensible Mark-up Language), and XSL (eXtnesible Stylesheet Language), but could be equally stored using other mark-up languages or as a database. XML requires pairs of tags, or identifiers, to be placed within a document. Theses tags do not specify how the information should be presented, but specify the content of the information between the pairs of tags. The skilled person will fully understand XML, but a full description can be found at http://www.w3.org, and the brief description below will aid his/her understanding. An archive of this site may be found at http://web.archive.org/web/*/http://www.w3.org which also contains information about XML.

The skilled person will appreciate how data written as an XML document is structured: written in words, or data sub-items, which are collected into data sub-item groups. The data sub-item groups can comprise sentences, paragraphs, or simply collections of words. The data sub-item groups, or even just data sub-items, are placed between pairs of tags, or identifiers.

The tags, or identifiers, appear as follows: <variable>, and </variable>, with variable being any word, or character string acceptable according to the XML recommendation. Further, each data sub item group can be itself broken down into a number of sub-items. This structure is convenient and allows for easy manipulation and searching of the complete data item. Each data sub-item group may of course be considered as a portion of the data.

Data that is intended for transmission to data-receiving devices is written, in this embodiment, in XML and a suitable code fragment is as follows:

1 <NavigationMenu priority=“high” intent=“navigation”>

2 <item name=“item1” . . . >Item1</item1>

3 <item name=“item2” . . . >Item2</item2>

4 . . .

5 </NavigationMenu>

6

7 <textElement priority=“high” intent=“title”>Title</textElement>

8 <textElement priority=“high” intent=“content”>TextA</textElement>

9 <textElement priority=“medium” intent=“content”>TextB</textElement>

10 <PicElement priority=“low” intent=“picture”>Picture</picElement>

It can be seen from the above code fragment that data-sub item groups (in this example the items of the Navigation Menu specified in lines 1 to 5, the title, TextA, TextB and the Picture are all provided with both a priority and an intent within the tag, or identifier, specifying the data-sub item). For example, the items of the Navigation Menu (within the <NavigationMenu> tags have a high priority and the intent is for navigation. In line 7 the title is specified within the <textElement> tag and has a high priority and its intent is as a title. In line 8 of the code TextA is specified between the <textElement> tags and has a high priority and an intended function as content. In line 9 of the code TextB is specified between the <textElement> tags and has a medium priority and an intended function as content. In line 10 of the code the picture is specified between the <picElement> tags and has a low priority and an intended function as a picture.

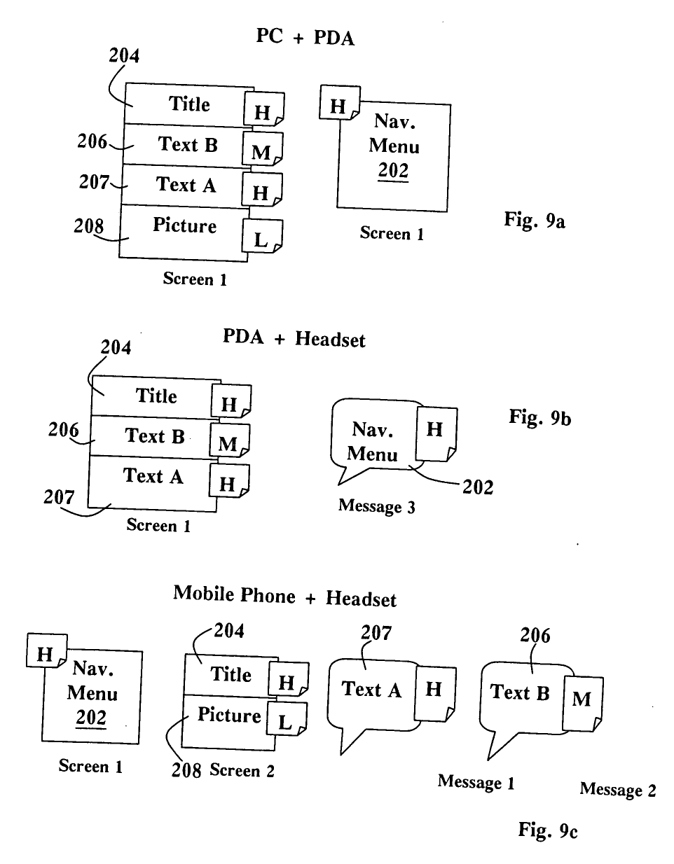

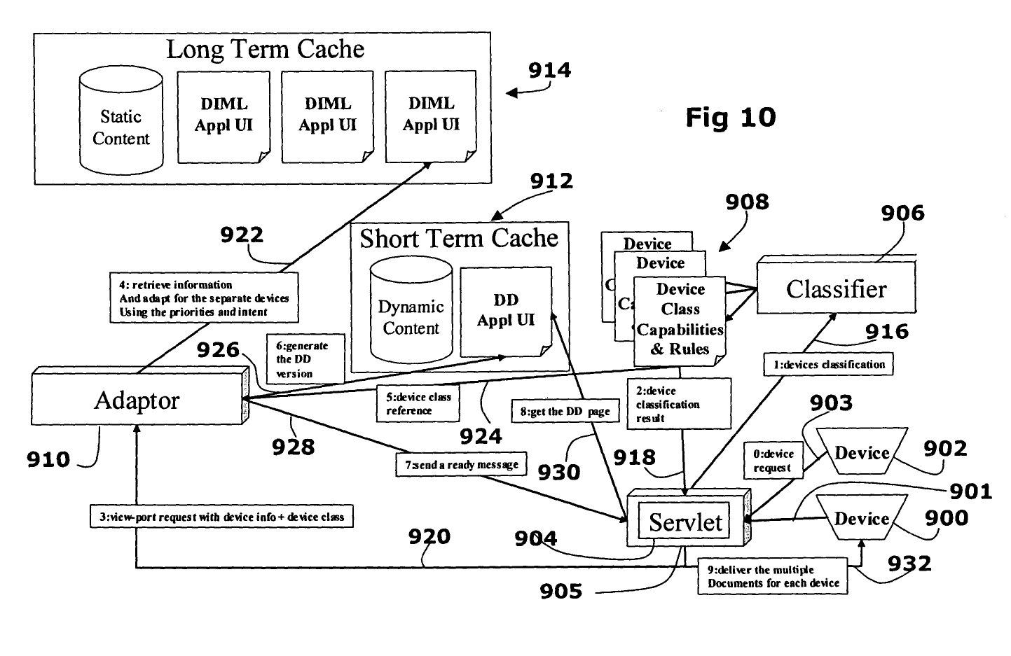

The use of these priorities is explained in relation to FIGS. 9 and 10 which show a first 900 and a second 902 device connected to a transmitting and receiving means 905 of a device herein called a servlet 904 via respective communication links 901, 903. In this example the first device 900 is a PDA (as for example described in relation to FIG. 5) and the connection 901 which connects the second device to the servlet 904 is a WIFI (IEEE 802.11). The second device 902 is a PC as described in relation to FIG. 6 and the connection connecting the second device 902 to the servlet 904 is a broadband connection.

Residing on the servlet 904, or accessible by the servlet 904 across a network connection thereto, there are provided a classifier 906 that is capable of classifying the first 900 and second 902 devices into a set of predetermined classifications (for example sound only, low capability display, medium capability display, high capability display). The classifier 906 has access to a set of capabilities and rules 908 (which may be thought of as a set of conditions) for each of the classifications. A long term cache 914 is provided on which data for the web site and web site portions 202,204,206,208 is held, generally, in a device independent manner.

An adapter 910 is provided and which can access both the long term cache 914 and the set of capabilities and rules 908 and can store device dependent data in a short term cache 912 that has been adapted from data held in the long term cache 914 using the capabilities and rules 908.

In order for this embodiment to function correctly when the PDA 900 and the PC 902 connect to the servlet 904 a request is made to the servlet 904 for them to be treated as a single session and given a single session i.d.; i.e. a pair of devices. As each device logs onto the servlet 904 it sends a message according to a predetermined format giving a session ID. A second device to be used in conjunction with that devices sends a message giving the same session ID.

To receive data one of the devices, in the embodiment shown the second device 902, sends a request to the servlet 904. This request is made according to standard protocols, such as for example HyperText Transport Protocol (http), which will not be described further.

The servlet 904 then sends a request 916 to the classifier 906 for a classification for the device 902 sending the request and an appropriate set of rules to be used for that device 902. A response is made by the classifier 906 and the device classification result 918 is sent to the servlet 904.

Once the result 918 has been received from the classifier 906 the servlet 904 sends a request 920 (a view port request with device information and device class) to the adapter 910 along with information about the device 902 for which the request is being made together with the class into which that device has been classified.

The adapter 910 retrieves 922 data that the device 902 has requested from the long term cache 914 and by referring 924 to the device class capabilities and rules 908 (it is known to which class the device 902 belongs since this has been specified in the request 920) a version of the data that meets the rules is sent for storage 926 in the short term cache 912. The data stored in the short term cache 912 is in a format suitable for sending directly to one of the devices 900, 902.

Because the two devices 900, 902 are being treated as a pair for this session the data may not be sent to the device that requested the data. The device class capabilities and rules 908 specify to which of the pair 900,902 data will be sent depending upon both the priority and intent provided in the tags associated with a particular data sub item group.

When the data suitable for sending to the appropriate device 900,902 has been successfully sent to the short term cache 912 then a message 928 is sent from the adapter 910 to the servlet 904 stating the data has been stored and is ready for transmission to one of the devices 900, 902. The message 928 provides the servlet 904 with a reference that specifies the location of the data within the short term cache 912. This location may be given as a URL. The servlet 904 then accesses 930 the short term cache 912 and retrieves the data stored therein using the reference that it has been passed from the adapter 910.

The data is then sent by the servlet 904 to the appropriate device 900 in a transmission 932. It should be noted that in the embodiment shown that it was the PC 902 that made the request 903 for data but that data was delivered to the PDA 900.

As will now be described, it is the device class capabilities and rules 908 that specify how data will be sent to the devices connected to the servlet 904. This specification may be for how data is sent to a single device, or to a pair of devices (for example devices 900,902 as in this embodiment) and uses XML tags appearing in the data which specify the importance of the data sub item groups in conjunction with rules that specify the authors “intent” (rules of intent) for how the data should be treated.

FIG. 9 shows how the web portions 202-208 of FIGS. 2 and 8 may be divided between a pair of devices. FIG. 9a shows the combination of a PC 28 and a PDA 26. The rules may state that navigation elements (i.e. intent=“navigation”) are sent to the PDA 26, irrespective of their priority, and that other elements are sent to the PC 28, again irrespective of their priority. Therefore, as can be seen from the Figure the title 204, TextB 206, TextA 207 and the picture 208 are sent to the PC 28 and the navigation menu 202 is sent to the PDA 26. This rule may be written as:

IF intent=“navigation” THEN device=“PDA”

ELSE THEN device=“PC”

FIG. 9b shows what may happen if a PDA 26 and a headset 23 are used in combination. In this example the rules state that navigation elements (i.e. intent=“navigation”) are sent to the headset 23 irrespective of their priority and that any other items having a medium or high priority are sent to the PDA 26. Therefore, the title 204, TextB 206 and TextA 207 appear on the PDA 26 and the navigation menu is announced by the headset 23. It would be possible to express this rule as:

IF intent=“navigation” THEN device=“headset”

ELSE IF priority=“medium” OR priority=“high” THEN device=PDA

FIG. 9c shows how data may be divided between a telephone 24 and a headset 23. In this example, the rules state that initially navigation elements are sent to the telephone as a priority and thereafter a separate screen title and picture element are sent to the telephone 24. Content elements are sent to the headset 23, irrespective of their priority. Therefore, a first screen of the telephone shows the navigation menu 202 and a second screen sent to the telephone shows the title 204, and the picture 208 (a thumbnail, description, or the like may be sent to the telephone according to the display characteristics of the telephone). Two messages are then sent to the headset 23. The first message contains TextA 207 since this is high priority and a second message contains TextB 206 because this was of lower priority. This rule may be written as:

IF intent=“navigation” OR intent=“Title” OR intent=“Pic element” then device=WAP

ELSE IF intent=“content” then device Headset

In some embodiments a user of a device, or pair of devices 900,902 may be able to alter the default rules and may be able to create a set of rules specific to them. These user specific rules are held in the device class capabilities and rules 908 such that when that user is logged on the rules that have been created specifically for them are used rather than the standard ones.

What we claim is:

1. A method of generating data suitable for transmission to at least one of a predetermined combination of at least a first and a second data-receiving device, the method comprising providing data, at least one rule, and identifiers, wherein the identifiers are associated with portions of the data and are arranged to identity that portion of the data, and the at least one rule specifies for the predetermined combination of first and second data-receiving devices to which device a portion of the data having a predetermined identifier should be sent and the method further comprising selecting portions of the data for transmission to at least one of the data-receiving devices depending upon the at least one rule.

2. A method according to claim 1 in which the identifiers are placed within the data prior to the generation of the data suitable for transmission.

3. A method according to claim 1 in which the identifiers provide an indication as to the intended function of the portion of the data with which they are associated.

4. A method according to claim 3 in which the rules specify to which device a portion of data should be sent according the intended function of that portion of data.

5. A method according to claim 1 in which the identifiers provide an indication of the importance of a portion of data relative to other portions of the same data.

6. A method according to claim 5 in which the rules specify to which device a portion of data should be sent according to the importance of the portion of data.

7. A method according to claim 1 which comprises generating a set of rules which are used as a default in order to determine to which data-receiving device the data should be sent.

8. A method according to claim 1 in which a user may alter the rules.

9. A method according to claim 1 in which the method comprises writing the data in a data-receiving device independent language.

10. A computing device arranged to hold data intended for transmission to at least one of a predetermined combination of at least a first and a second data-receiving devices, the computing device comprising a processor arranged to process data, a transmitter arranged to receive data from the processor and to transmit data from the device, a receiver arranged to receive data to the device and to pass the data to the processor, storage arranged to store data together with a set of rules determining how data should be processed and to allow the processor to access the data and the rules stored in the storage, wherein the receiver is arranged to receive a request for data and pass the request to the processor, the processor being arranged to access data stored in the storage, determine to which of the at least two data-receiving devices at least a portion of the data should be sent according to the rules held in the storage together with identifiers held within the data and further arranged to pass the data, that the processor determines should be transmitted, to the transmitter wherein the transmitter is arranged to transmit the data it has been passed to at least one of the data-receiving devices.

11. A computing device according to claim 10 which is connected to a network and in which the data receiver and data transmitter are arranged to connect the computing device to the network.

12. A computing device according to claim 10 in which the device is one of a server and a router.

13. A device arranged to concurrently establish a data connection between a computing device and at least a first and a second data-receiving device such that data is sent to one of the first and the second data receiving devices depending upon an identifier within the data wherein the first and the second data-receiving devices are intended to be used in conjunction, the device comprising a receiver arranged to receive data from the data connection, a transmitter arranged to send data over the data connection and a processor arranged to process data and to control the receiver and the transmitter, the device being arranged such that when it establishes the data connection the receiver is arranged to receive the identity of the first and the second data-receiving devices.

14. A device according to claim 13 which is arranged to send an amount of data such that at least some of the data is sent to the first data receiving device and at least some of the data is sent to the second data receiving device.

15. A network comprising at least one computing device and at least two data receiving devices, the computing device being arranged to make data connections to the at least two data receiving devices used in conjunction with one another such that predetermined data is handled by one of the data handling devices and other predetermined data is handled by another of the data handling devices, the computing device comprising a processor arranged to process data, a transmitter arranged to receive data from the processor and to transmit data from the computing device, a receiver arranged to receive data to the computing device and to pass data to the processor, memory arranged to store data together with a set of rules determining how data should be processed and to allow the processor to access the data and rules, wherein the receiver is arranged to receive a request for data and pass the request to the processor, the processor being arranged to access data stored in the memory, determine to which of the at least two data receivers at least a portion of the data should be sent according to the rules held in the memory together with identifiers held within the data and further arranged to pass the data that the processor determines should be transmitted to the transmitter and wherein the transmitter is arranged to transmit the data it has been passed to at least one of the data receiving devices and the at least two data-receiving devices being arranged to receive data from the computing device.

16. A computer readable medium containing instructions which when read onto a processing unit cause that processing unit to perform the method of claim 1.

17. A computer readable medium containing instructions which when read onto a processing unit to function as the computing means of claim 10.

18. A computer readable medium containing instructions which when read onto a data-receiving device cause that data-receiving device to function as one of the data-receiving devices according to claim 13.

19. A computer readable medium containing instructions which when read onto a computer on a network cause that network to function according to claim 15.

20. A method of generating data suitable for transmission to at least one of a predetermined combination of at least a first and a second data-receiving device, the method comprising providing data, at least one rule and identifiers, wherein the identifiers are associated with portions of the data and are arranged to identify that portion of the data and the at least one rule specifies for the predetermined combination of first and second data-receiving devices to which device a portion of the data having a predetermined identifier should be sent and the method further comprising selecting portions of the data for transmission to at least one of the data-receiving devices depending upon the at least one rule, wherein the identifiers provide an indication as to the intended function of the portion of the data with which they are associated and the rules specify to which of the first and the second devices data should be sent.

21. A method according to claim 20 in which the identifiers provide an indication as to the intended function of the portion of the data with which they are associated.

22. A method according to claim 21 in which the rules specify to which device a portion of data should be sent according the intended function of that portion of data.

23. A method of creating data intended for transmission to at least one of a combination of at least a first and a second data-receiving device, the method comprising providing data, at least one condition and identifiers, wherein an identifier is associated with a portion of the data and is arranged to identify that portion of the data, and the at least one condition specifies for the combination of first and second data-receiving devices to which device a portion of the data having a predetermined identifier should be sent and the method further comprising selecting portions of the data for transmission to at least one of the data-receiving devices depending upon the at least one condition.

24. A network comprising at least one computing device and at least two data receiving devices, the computing device being arranged to make data connections to the at least two data receiving devices used in conjunction with one another such that predetermined data is handled by one of the data handling devices and other predetermined data is handled by another of the data handling devices, the computing device comprising a processor, a transmitter, a receiver, and a memory arranged to store data including identifiers identifying predetermined data to be sent to one of the data receiving devices together with a set of rules determining how data should be processed, wherein the receiver is arranged to receive a request for data and pass the request to the processor, the processor being arranged to access data stored in the memory, determine to which of the at least two data receiving devices at least a portion of the data should be sent according to the rules held in the memory together with the identifiers held within the data and further arranged to pass the data that the processor determines should be transmitted to the transmitter and wherein the transmitter is arranged to transmit the data it has been passed to at least one of the data receiving devices at any one time and the at least one data-receiving devices being arranged to receive data from the computing device.

25. A device arranged to concurrently establish a data connection with at least a first and a second data-receiving device such that data is sent to one of the first and the second data receiving devices depending upon an identifier within the data wherein the data-receiving devices are intended to be used in conjunction with one another, the device comprising a receiver arranged to receive data from the data connection, a transmitter arranged to send data over the data connection and a processor arranged to process data and to control the receiver and the transmitter, the device being arranged such that when it establishes the data connection the processor is arranged to receive from the receiver the identity of the first and the second data-receiving devices, the device being further arranged to receive data at least a portion of which is intended for the first data-receiving device and at least a portion of which is intended for the second data-receiving device and the processor being further arranged to control the transmitter to transmit each of the portions of the data to the data-receiving device for which they are intended such that at least some of the data is received by the first data receiving device and at least some of the data is received by the second data receiving device.

26. A device according to claim 25 which is provided within a network and arranged to receive the data from the network.

27. A device arranged to concurrently establish a data connection between a computing device and at least a first and a second data-receiving device such that data is sent to one of the first and the second data receiving devices depending upon an identifier within the data wherein the first and the second data-receiving devices are intended to be used in conjunction, the device comprising a receiver arranged to receive data from the data connection, a transmitter arranged to send data over the data connection and a processor arranged to process data and to control the receiver and the transmitter.
